(19) United States
(12) Patent Application Publication
(10) Pub. No.: US 2014/0150345 A1
(43) Pub. Date: Jun. 5, 2014

(54) HINGE ASSEMBLY, DOOR ASSEMBLY AND RELATED METHODS

(71) Applicant: Paul Spencer Price, Warrington (GB)

(72) Inventor: Paul Spencer Price, Warrington (GB)

(21) Appl. No.: 14/131,127

(22) PCT Filed: Jul. 6, 2012
(86) PCT No.: PCT/GB2012/051603

§ 371 Date: Jan. 6, 2014

(30) Foreign Application Priority Data
Jul. 6, 2011 (GB) 1111529.2

(51) Int. Cl. E05D 7/00

(52) U.S. Cl. CPC E05D 7/0018
USPC 49/381; 16/221; 16/235; 16/246; 16/319; 49/506

(57) ABSTRACT

A hinge assembly comprising first and second hinge plates mounted for relative rotation about a pivot. The first hinge plate comprises a mount for coupling to a door component and the hinge assembly is arranged to permit a degree of relative linear movement between the second hinge plate and a door component coupled to the mount, independent of the relative rotational position of the first and second hinge plates within their range of relative rotation about the pivot.

### FIELD OF THE INVENTION

The present invention relates to hinge assemblies. The present invention further relates to door assemblies comprising a hinge assembly, and to related methods.

### BACKGROUND TO THE INVENTION

Presently, there is considerable interest in providing flood defence structures for buildings. Typically, at times of expected flooding a flood defence panel is provided to form a barrier across a doorway into a building to resist ingress of water. However, this approach requires additional fixing structures and sealing features at the doorway, and in ineffective in preventing ingress of flood water unless the panel is in place at the time of flooding.

Modifying a standard door to resist ingress of flood water is not straightforward as the modified door must still provide easy access when required, along with its normal security and draft proofing functions.

Example embodiments of the present invention aim to address at least one problem associated with the prior art, whether identified herein or otherwise.

### SUMMARY OF THE INVENTION

In a first aspect, the present invention provides a hinge assembly comprising first and second hinge plates mounted for relative rotation about a pivot, the first hinge plate comprising a mount for coupling to a door component, the hinge assembly arranged to permit a degree of relative linear movement between the second hinge plate and a door component coupled to the mount, independent of the relative rotational position of the first and second hinge plates within their range of relative rotation about the pivot.

Suitably, the mount is arranged such that linear movement is permitted in a direction parallel to the plane of the first hinge plate. Suitably, the mount is arranged such that linear movement is permitted in a radial direction, perpendicular to the axis of the pivot. Suitably, the mount is arranged to cooperate with the first hinge plate such that linear movement is restricted to movement in a single dimension.

Suitably, the mount is arranged to cooperate with the first hinge plate such that relative linear movement is possible in two non-parallel directions. Suitably, the mount is arranged to cooperate with the first hinge plate such that linear movement is possible in two perpendicular directions. Suitably, the mount is arranged to cooperate with the first hinge plate such that linear movement is possible in only two perpendicular directions.

Suitably, the pivot of the hinge assembly is arranged to permit a degree of linear movement between the first and second hinge plates in a direction parallel to the pivot axis, and comprises an adjustment means to set the position of the first hinge plate relative to the second hinge plate on the pivot axis such that the relative position does not change as the first and second hinge plates move about the pivot axis. Suitably, the adjustment means comprises an adjusting screw. Suitably, the adjusting screw is arranged on the pivot axis of the hinge.

Suitably, the hinge assembly comprises locking means arrangeable to fix the relative position of the mount and the first hinge plate. Suitably, the locking means is arranged to clamp the mount to the first hinge plate. Suitably, the locking means is arranged on an opposite sides of the first hinge plate to the mount, and is coupled to the mount through the first hinge plate.

Suitably, the hinge assembly comprises biasing means arranged to bias the mount toward the pivot. Suitably, the biasing means is arranged between the first hinge plate and the mount. Suitably, the biasing means is arranged to push the mount in a direction parallel to the first hinge plate. Suitably, the biasing means is compressible under force from the mount to move the mount away from the pivot. Suitably, the biasing means is arranged to act parallel to the permitted movement of the mount relative to the first hinge plate.

Suitably, the mount comprises a recessed portion into which the first hinge plate locates. Suitably, the first hinge plate comprises opposed walls extending from a surface thereof, and between which the mount is arranged to locate. Suitably, the recessed portion of the mount is arranged to locate between the opposed walls of the first hinge plate. Suitably, the mount comprises a mounting extension that extends beyond the first hinge plate to enable the hinge assembly to be coupled to a door component using the extension. Suitably, the mount comprises two mounting extensions, each extending beyond the first hinge plate to enable the hinge assembly to be coupled to a door component. Suitably, the recessed portion of the mount is recessed relative to the mounting extensions. Suitably, one or both of the mounting extensions are arranged to bear on edge portions of the first hinge plate. Suitably, the mounting extensions are arranged to slidably engage the edges of the first hinge plate. Suitably, cooperation between the mounting extensions and the edges of the first hinge plate defines the permitted movements of the mount relative to the first hinge plate.

Suitably, the mount comprises a projection that extends into an opening or recess on the first hinge plate. Suitably, the mount comprises a projection which is arranged to slidably engage the edges of an opening or recess on the first hinge plate. Suitably, cooperation between the projection on the mount and the edges of the opening or recess on the first hinge plate defines the permitted movements of the mount relative to the first hinge plate. Suitably, the opening or recess comprises opposed parallel edges, arranged to cooperate with opposed parallel edges of the projection. Suitably, an edge of the mount and recess are substantially linear in respect of their cooperation or engagement. Suitably, the mount comprises a plurality of said projections, and the first hinge plate the opening or recess. Suitably, the projections comprise a threaded bore or other fastening feature for use in securing the locking means to the mount. In other embodiments the mount may comprise the recess or opening and the first hinge plate may comprise the projection as described.

Suitably, the second hinge plate comprises one or more of, including all of the features of the first hinge plate.

Suitably, the door component comprises a door, preferably a side face of the door. Suitably, the door component comprises a door frame, preferably a side face of a door frame.

In a second aspect the present invention comprises a door assembly including a door, a hinge assembly according to the first aspect of the present invention, wherein the mount is attached to the door.

Suitably, the door assembly comprises a door coupled to the mount, and a door frame coupled to the second hinge plate. Suitably, the mount is arranged in use to hold the first hinge plate to the door. Suitably, the mount comprises mounting extensions, and the first hinge plate is held between the mounting extensions.

Suitably, the hinge assembly comprises a hinge assembly inducing biasing means as described above in relation to the first aspect of the invention, and further comprises actuation means arranged to move the door against the bias of the biasing means. Suitably, the actuation means is arranged to move the door toward the door frame, against the bias of the biasing means. Suitably, the actuation means provides multiple points of engagement between the door and the door frame, and is arranged to press the door against the door frame.

Suitably, the door assembly comprises a sealing element between the door frame and the door. Suitably the sealing element comprises a rubber strip. The sealing element may comprise part of the door, or part of the door frame.

Suitably, the door assembly comprises two, or more than two hinge assemblies as described above.

In a third aspect the present invention comprises a method of engaging a door with a door frame, comprising:
arranging a hinge assembly to couple the door and the door frame, the hinge assembly comprising first and second hinge plates mounted for relative rotation about a pivot, the first hinge plate comprising a mount for coupling to the door or door frame, the hinge assembly arranged to permit a degree of relative linear movement between the second hinge plate and the door or door frame coupled to the mount, independent of the relative rotational position of the first and second hinge plates within their range of relative rotation about the pivot, and

pressing the door against the door frame to move the mount relative to the second hinge plate.

Suitably, the pressing comprises pressing the door to produce translation movement of the door relative to the door frame. Suitably, the pressing comprises pressing the door into the door frame. Suitably, the pressing comprises pressing the door against a sealing element between the door and the door frame. Suitably, the pressing comprises moving the door against the bias of a biasing means. Suitably, the pressing comprises moving the portion of the door nearest to the hinge assembly and the portion of the door furthest across from the hinge assembly in generally parallel directions and by the same amount of linear distance.

Suitably, the method comprises operating actuation means to press the door against the door frame. Suitably, the method comprises holding the door in place in the door frame using actuation means. Suitably, the method comprises operating actuation means to move the door against the door frame, against the bias of biasing means. Suitably, the method comprises operating actuation means that provides multiple points of engagement between the door and the door frame to press the door against the door frame. Suitably, the method comprises operating the actuation means to press the door against the door frame and to lock the door in place.

### BRIEF INTRODUCTION TO THE FIGURES

For a better understanding of the invention, and to show how embodiments of the same may be carried into effect, reference will now be made, by way of example, to the accompanying diagrammatic drawings in which:

FIGS. 1-5 show hinge assemblies according to example embodiments of the present invention;

FIGS. 6 and 7 show the hinge assembly of FIG. 5 in more detail;

FIG. 8-10 show an actuation means for use with example embodiments of the present invention; and

FIG. 11 shows sealing elements for use with example embodiments of the present invention.

### DESCRIPTION OF EXAMPLE EMBODIMENTS

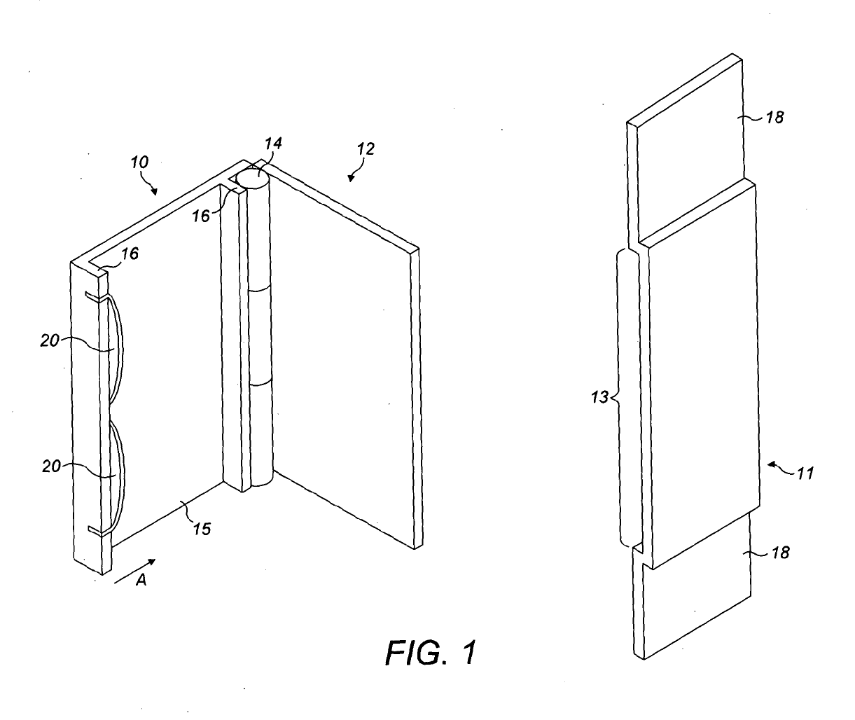

Referring to FIG. 1 there is shown a hinge assembly comprising first and second hinge plates 10, 12 mounted for relative rotation about a pivot 14. The first hinge plate 10 comprises a mount 11 for coupling to a door component. In the embodiment of FIG. 1 the first hinge plate 10 and the mount 11 thereof are for coupling to a door, and the second hinge plate is for coupling to a door frame. The hinge assembly is arranged to permit a degree of relative linear movement between the second hinge plate 12 and a door coupled to the mount 11, the degree of linear movement being independent of the relative rotational position of the first and second hinge plates 10, 12 within their range of relative rotation about the pivot 14.

Using the hinge assembly in this way a door coupled to the mount 11 can move in a linear translational fashion into and against the door frame when the door is shut in the door frame. Pressing on the door can move the portion of the door nearest to the hinge assembly and the portion of the door furthest across from the hinge assembly in generally parallel directions and by the same amount of linear distance. Normally, with a hinge which is arranged with hinge plates that only pivot relative to one another, pressing the door will not move portions of the door coupled to the first hinge plate any closer to the door frame as the portions of the door further across the door form the hinge bear on the door frame. The standard door arrangement potentially results in a poor fit between the door and the door frame, and can thus prevent adequate sealing against drafts and ingress of water.

In the embodiment of FIG. 1, the mount 11 is arranged such that linear movement is permitted in a direction A parallel to a planar face 15 of the first hinge plate 10. The direction A as indicated corresponds to linear movement in a radial direction, perpendicular to the axis of the pivot 14. The mount 11 is arranged to cooperate with other features of the first hinge plate 10 such that linear movement is restricted to movement backward and forward in a single dimension.

The mount 11 comprises a recessed portion 13 into which the first hinge plate 10 locates in use. Also, the first hinge plate 10 comprises opposed walls 16 extending from the planar surface 15, between which the mount 11 is in use arranged to locate. In the embodiment of FIG. 1, the recessed portion 13 locates between the opposed walls 16. To either side of the recessed portion 13 the mount 11 comprises mounting extensions 18 that extend beyond the planar surface 15 of the first hinge plate to enable the hinge assembly to be coupled to a door component. The recessed portion 13 of the mount 11 is recessed relative to the mounting extensions 18. A typical installation of the hinge assembly of FIG. 1 might comprise fixing through the extensions 18 into the side face of a door, for example using screws.

The mounting extensions 18 are arranged to slidably engage the edges of planar surface 15 of the first hinge plate 10, such that cooperation between the mounting extensions 18 and the edges contribute to defining the permitted movements of the mount 11 of the first hinge plate 10.

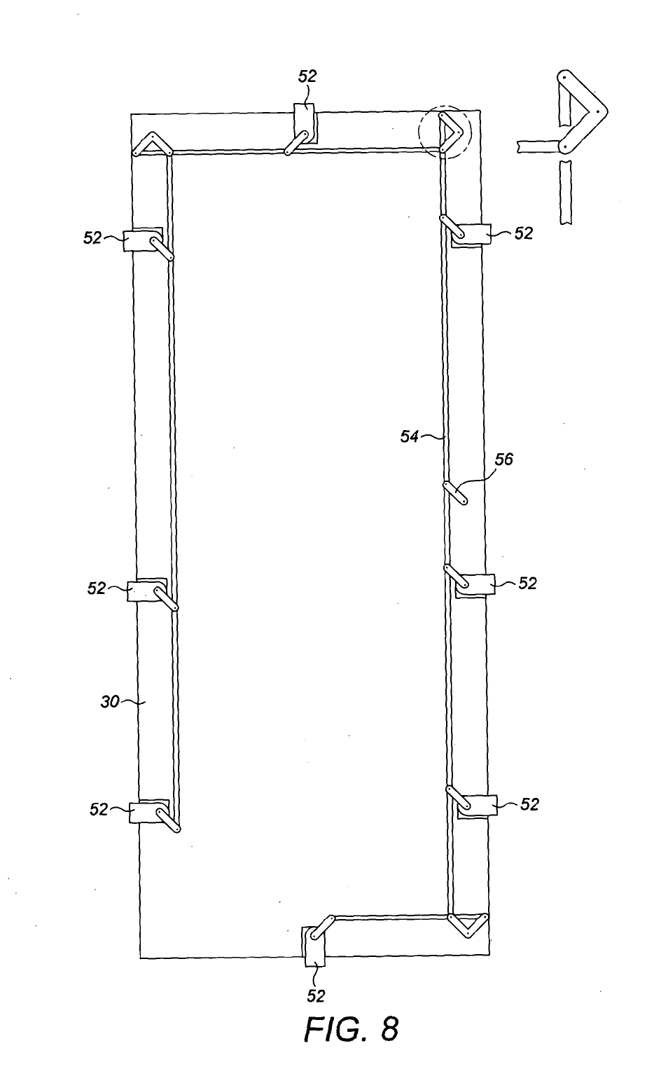

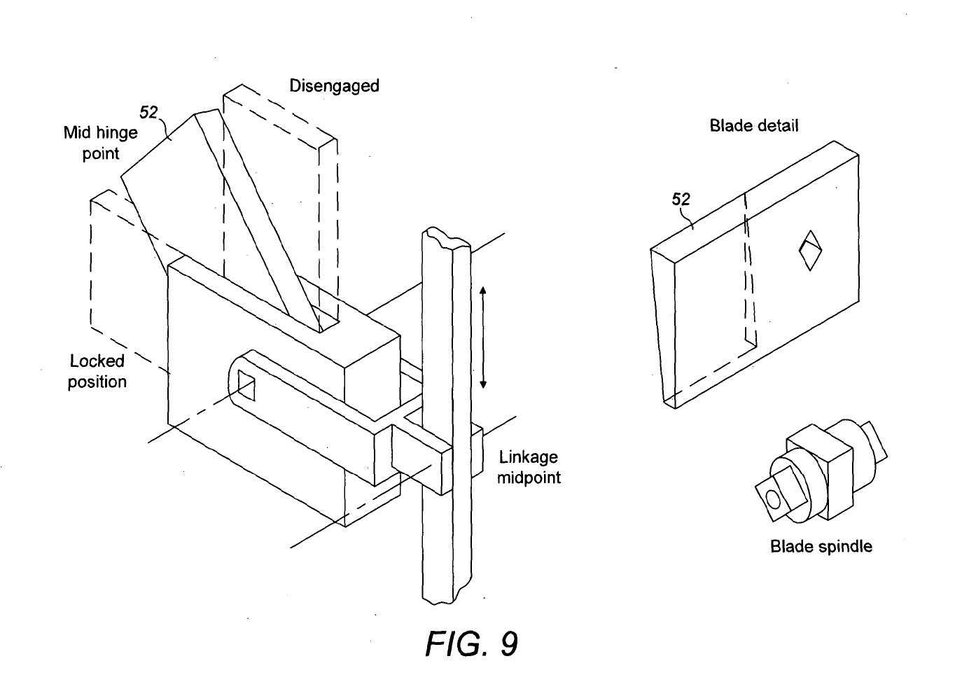

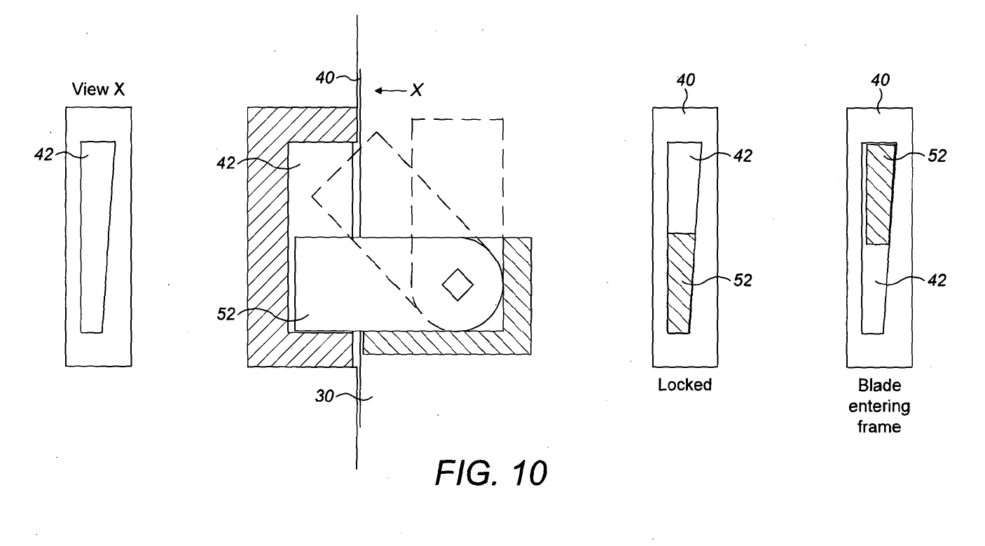

Also relevant to the movement of the mount 11 of the first hinge plate 10 is biasing means 20 arranged to bias the mount 11 toward the pivot 14. In the embodiment of FIG. 1 the biasing means 20 comprises a pair of sprung steel blades, of depth comparable to the wall 16 and compressible to move 2 mm between extended and fully elastically compressed configurations. The biasing means 20 is arranged between a wall 16 of the first hinge plate and the mount 11 and is arranged to push the mount 11 in a direction parallel to the planar face 15 of the first hinge plate 10. The biasing means 20 is compressible under force from the mount 11 to move the mount away from the pivot 14. The biasing means 20 is arranged to act parallel to the direction A. In normal operation of the door to which the hinge assembly is fixed, the biasing means 20 holds the mount 11 over in the direction A, close to the pivot 14. Pressing the door away from the pivot 14 against the bias of the biasing means 20 enables the door to move evenly against the door frame, enabling a good seal to be formed between the two. The operation of pressing and holding the door against the door frame will now be described in more detail, with reference to FIGS. 8-11.

FIGS. 8-10 show a door assembly including a door, a hinge assembly as described above and a door frame 40. The door 30 is coupled to the mount 11 using the extensions 18, and the door frame 40 coupled to the second hinge plate 12. FIGS. 8-10 also show an actuation means arranged to move the door 30 against the bias of the biasing means 20 and to lock the door 30 in place in the door frame 40. The actuation means is in part carried on the door 30 and provides multiple points of engagement between the door 30 and the door frame 40, in the form of blades 52 arranged to pivot into and press against recesses 42 in the door frame 40. The blades 52 and coupled by a linkage 54 so as to all operate in response to a users actuation input, for example in response to a user turning a handle about actuation point 56. The recesses 42 comprise tapered sockets, arranged to urge the blades 52, and correspondingly to urge the door 30 away from the pivot 14 as the blades move into place in the frame 40. The actuation means can in further embodiments (not shown) conveniently be coupled to a locking arrangement, to give an integrated security benefit along with the benefit of properly sealing the door 30 against the door frame 40.

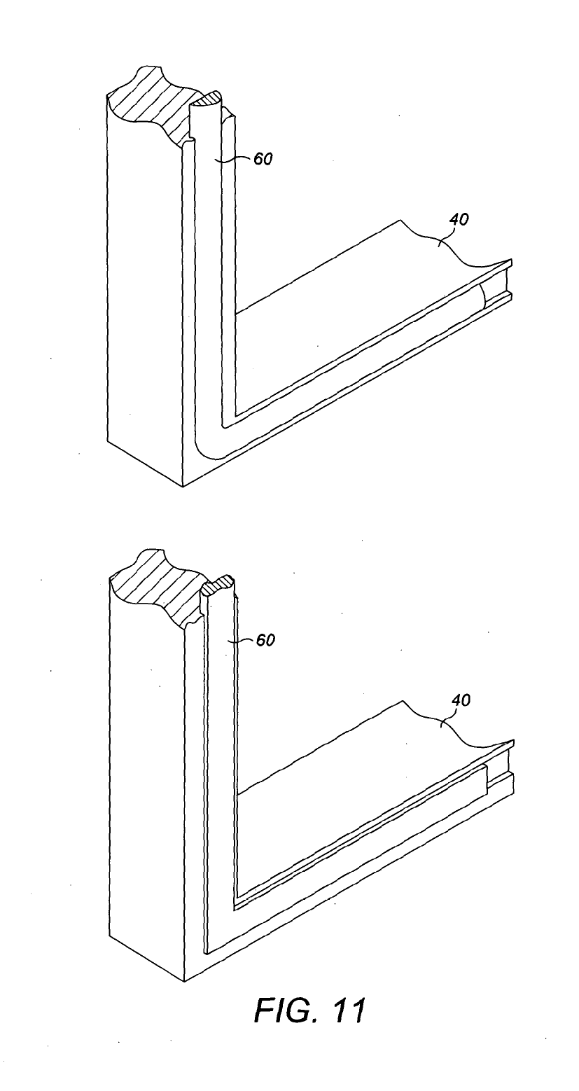

FIG. 11 shows a sealing element 60 in both half-round and rectangular section, positioned in the door frame 40 so as to lie between the door frame 40 and the door 30 when the door 30 is closed in the frame. The sealing element 60 comprises a rubber strip, and in alternative embodiments may be carried on the door 30 rather than on the door frame 40.

For a standard doorway in a domestic building the door assembly of FIGS. 8-11 may suitably comprise two, or three hinge assemblies as described above, but it will be appreciated that the size and number of hinge assemblies can be varied according the requirements of the door which is to be carried thereon. The dimensions given on the Figures are examples of those suitable for a standard doorway in a domestic building.

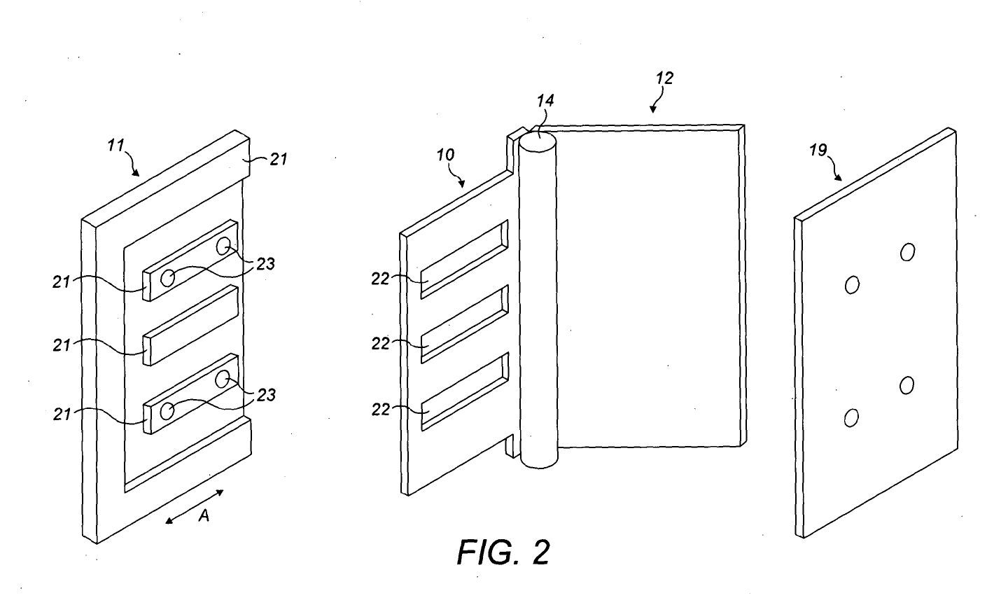

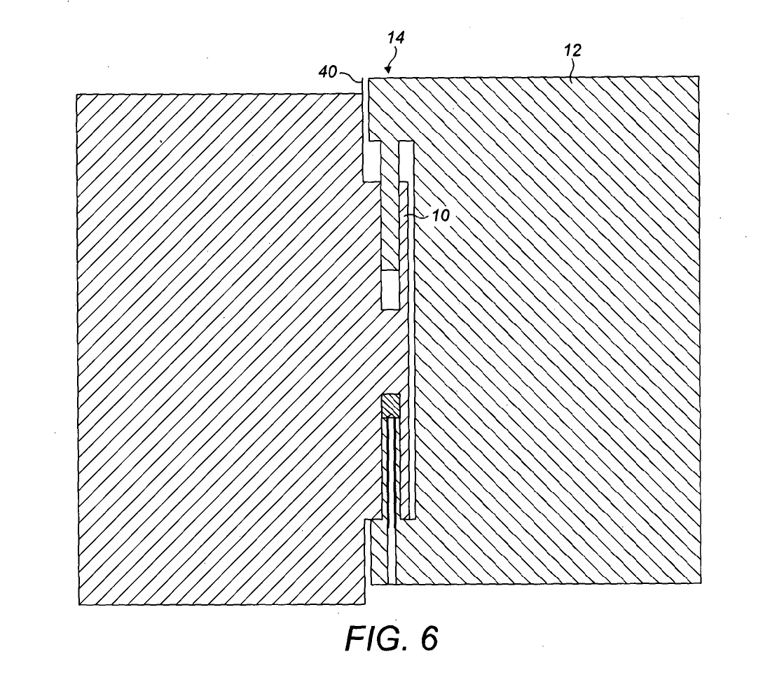

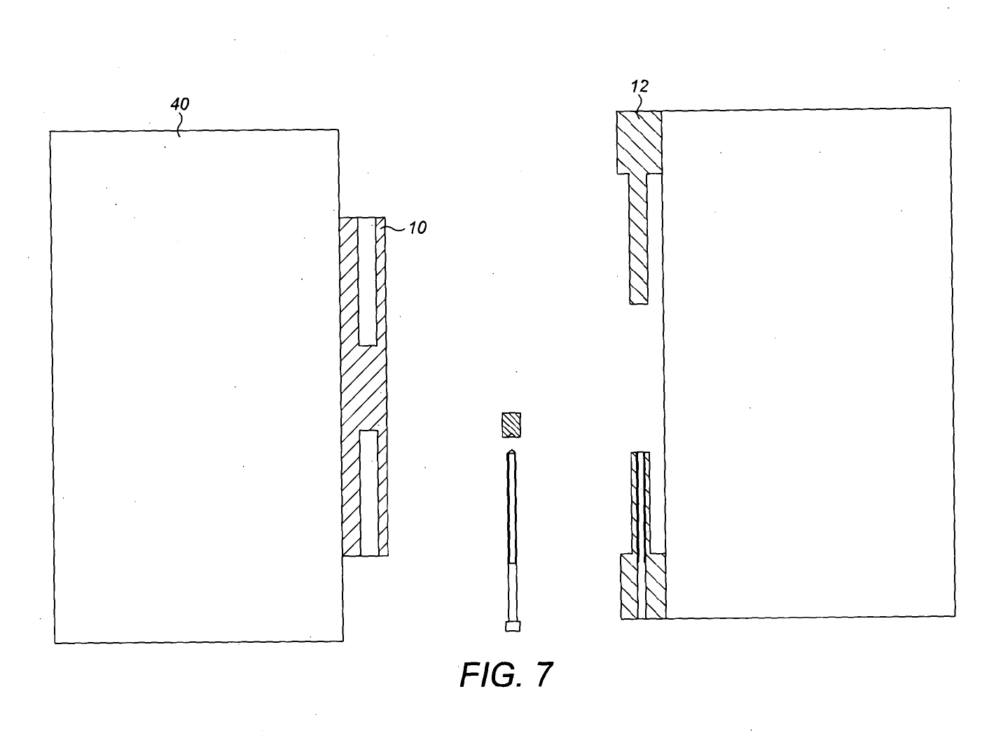

FIGS. 2-7 show further example hinge assemblies that permit a degree of adjustment to be made between the mount and a hinge plate. Although not shown the hinge assemblies of FIGS. 2-7 my further comprise biasing means and permit relative movement between hinge plate and mount, but may conveniently also enable the mount to be positioned relative to the hinge plate and then locked in place then subsequently re-adjusted to allow the mount to move to a different relative position before being again locked in place.

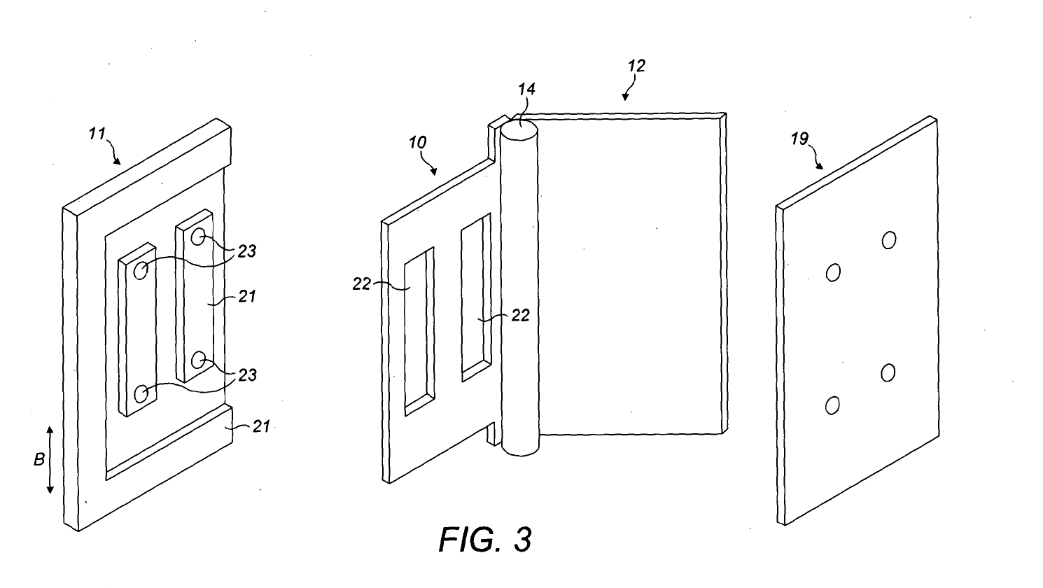

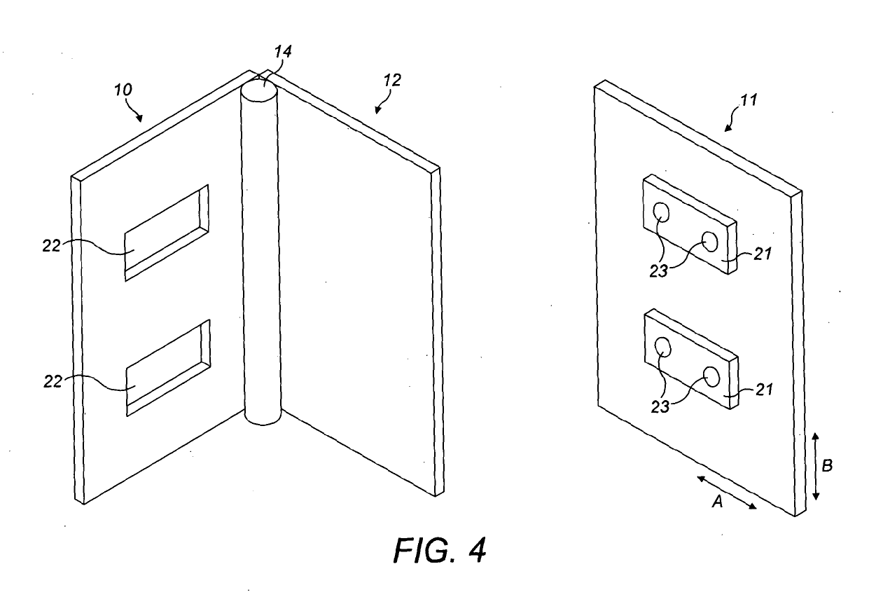

FIG. 2 shows a mount 11 comprising projections 21, some of which extend into openings 22 on the first hinge plate 10. The projections 21 are arranged to slidably engage the edges of the corresponding openings 22 on the first hinge plate 10, and edges of the first hinge plate 10, with cooperation between the projections 21 on the mount 11 and the edges on the first hinge plate 10 defining the permitted movements of the mount 11 relative to the first hinge plate 10. The FIG. 2 embodiment comprises projections 21 and openings 22 which enable movement in direction A, whereas FIG. 3 comprises projections 21 and openings 22 which enable movement in direction A and the perpendicular direction B. FIG. 4 shows and embodiment in which the projections 21 each extend over a generally smaller area than the corresponding openings 22, enabling relative movement to take place in directions A and B.

In each of FIGS. 2-4 some of the projections 21 comprise threaded bores 23 as fastening features for use in securing a locking means 19 to the mount 11, for example by screwing through the locking means 19 and clamping the mount 11 to the first hinge plate 10 to hold them together in the hinge assembly and to resist relative movement by surface friction therebetween. Some example embodiments may further comprise friction enhancing features to reduce the clamping force needed to lock the mount 11 in place.

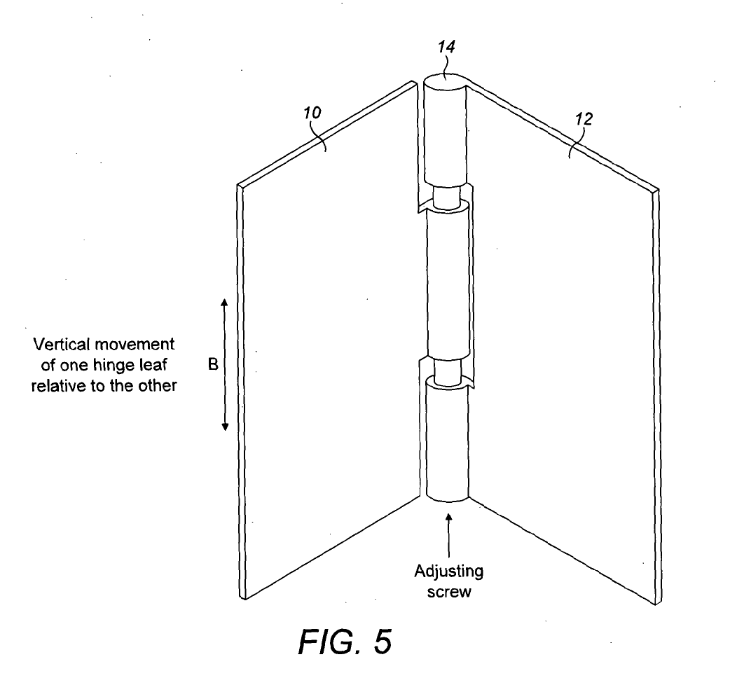

FIGS. 5-7 show an embodiment of the hinge assembly in which the pivot 14 is arranged to permit a degree of linear movement between the first and second hinge plates 10, 12 in a direction parallel to the pivot axis, and comprises an adjustment means in the form of a screw which is used to set the position of the first hinge plate relative to the second hinge plate on the pivot axis 14 such that the relative position does not change as the first and second hinge plates move about the pivot axis.

The embodiments described herein are of simple construction, but provide a useful modification to traditional hinges by enabling propose positioning of a door in a door frame. The properly positioned door can be highly draft and flood resistant.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A hinge assembly comprising first and second hinge plates mounted for relative rotation about a pivot, wherein:
the first hinge plate comprises a mount for coupling to a door component; and
the hinge assembly is arranged to permit a degree of relative linear movement between the second hinge plate and a door component coupled to the mount, independent of the relative rotational position of the first and second hinge plates within their range of relative rotation about the pivot.

2. The hinge assembly of claim 1, wherein the mount is arranged such that linear movement is permitted in a direction parallel to the plane of the first hinge plate.

3. The hinge assembly of claim 1, wherein the mount is arranged to cooperate with the first hinge plate such that relative linear movement is possible in two non-parallel directions.

4. The hinge assembly of claim 1, wherein the mount is arranged such that linear movement is permitted in a radial direction, perpendicular to the axis of the pivot.

5. The hinge assembly of claim 1, wherein the hinge assembly is arranged to permit a degree of linear movement between the first and second hinge plates in a direction parallel to the pivot axis, and comprises an adjustment means to set the position of the first hinge plate relative to the second hinge plate on the pivot axis such that the relative position does not change as the first and second hinge plates move about the pivot axis.

6. The hinge assembly of claim 5, wherein the adjustment means comprises an adjusting screw arranged on the pivot axis of the hinge.

7. The hinge assembly of claim 1 comprising locking means arrangeable to fix the relative position of the mount and the first hinge plate.

8. The hinge assembly of claim 7, wherein the locking means is arranged to clamp the mount to the first hinge plate.

9. The hinge assembly of claim 1 comprising biasing means arranged to bias the mount toward the pivot.

10. The hinge assembly of claim 9, wherein the biasing means is arranged between the first hinge plate and the mount, whereby the biasing means is arranged to push the mount in a direction parallel to the first hinge plate.

11. The hinge assembly of claim 9, wherein the biasing means is compressible under force from the mount to move the mount away from the pivot.

12. The hinge assembly of claim 1, wherein the mount comprises a recessed portion into which the first hinge plate locates.

13. The hinge assembly of claim 12, wherein the first hinge plate comprises opposed walls extending from a surface thereof, and between which the mount is arranged to locate whereby the recessed portion of the mount is arranged to locate between the opposed walls of the first hinge plate.

14. The hinge assembly of claim 12, wherein the mount comprises a mounting extension that extends beyond the first hinge plate to enable the hinge assembly to be coupled to a door component using the extension.

15. The hinge assembly of claim 14, wherein:
the mount comprises two mounting extensions, each extending beyond the first hinge plate to enable the hinge assembly to be coupled to a door component;
the recessed portion of the mount is recessed relative to the mounting extensions and one or both of the mounting extensions are arranged to bear on edge portions of the first hinge plate; and
the mounting extensions are arranged to slidably engage the edges of the first hinge plate.

16. The hinge assembly of claim 1, wherein:
the mount comprises a projection that extends into an opening or recess on the first hinge plate; and
the projection is arranged to slidably engage the edges of an opening or recess on the first hinge plate.

17. A door assembly including a door, a hinge assembly according to claim 1, wherein:
the mount is attached to the door;
the door assembly comprises a door coupled to the mount, and a door frame coupled to the second hinge plate;
the mount is arranged in use to hold the first hinge plate to the door; and
the mount comprises mounting extensions, and the first hinge plate is held between the mounting extensions.

18. The door assembly of claim 17, wherein the hinge assembly comprises:
a hinge assembly inducing biasing means arranged between the first hinge plate and the mount whereby the biasing means is arranged to push the mount in a direction parallel to the first hinge plate; and
actuation means arranged to move the door toward the door frame, against the bias of the biasing means.

19. The door assembly of claim 17 wherein the door assembly comprises a sealing element between the door frame and the door.

20. A method of engaging a door with a door frame, the method comprising steps of:
arranging a hinge assembly to couple the door and the door frame, the hinge assembly comprising first and second hinge plates mounted for relative rotation about a pivot, the first hinge plate comprising a mount for coupling to the door or door frame, the hinge assembly arranged to permit a degree of relative linear movement between the second hinge plate and the door or door frame coupled to the mount, independent of the relative rotational position of the first and second hinge plates within their range of relative rotation about the pivot; and
pressing the door against the door frame to move the mount relative to the second hinge plate.

21. The method of claim 20 wherein the pressing comprises pressing the door to produce translation movement of the door relative to the door frame.

22. The method of claim 20 comprising operating actuation means to press the door against the door frame and holding the door in place in the door frame using the actuation means.

23. (canceled)
